(19) United States
(12) Patent Application Publication
(10) Pub. No.: US 2024/0193845 A1
(43) Pub. Date: Jun. 13, 2024

(54) RENDERING METHOD AND DEVICE FOR IMPROVING REALISM OF RENDERED IMAGE

(71) Applicant: ELECTRONICS AND TELECOMMUNICATIONS RESEARCH INSTITUTE, Daejeon (KR)

(72) Inventors: Bon Woo HWANG, Daejeon (KR); Kinam KIM, Daejeon (KR); Tae-Joon KIM, Daejeon (KR); Seung Uk YOON, Daejeon (KR); Seung Wook LEE, Daejeon (KR)

(21) Appl. No.: 18/228,169

(22) Filed: Jul. 31, 2023

(30) Foreign Application Priority Data
Dec. 9, 2022 (KR) 10-2022-0171107

(51) Int. Cl. G06T 15/00; G06T 7/194

(52) U.S. Cl. CPC G06T 15/005; G06T 7/194; G06T 2207/20084

(57) ABSTRACT

Provided is a rendering method and a device for improving realism of a rendered image. The method includes receiving training image data including a real image, generating a rendering simulation image using the training image data, acquiring background feature information by separating foreground and background areas on the basis of the rendering simulation image or the training image data, acquiring latent feature information required for generating a realistic image on the basis of the rendering simulation image, and generating a realistic image on the basis of the latent feature information and the background feature information.

### CROSS-REFERENCE TO RELATED APPLICATION

This application claims priority to and the benefit of Korean Patent Application No. 10-2022-0171107 filed in the Korean Intellectual Property Office on Dec. 9, 2022, the disclosure of which is incorporated herein by reference in its entirety.

### BACKGROUND

### 1. Field of the Invention

The present invention relates to a technology for improving realism of a rendered image using a neural network.

### 2. Description of Related Art

Lately, the demand for three-dimensional (3D) content has been rapidly increasing due to an increase not only in games and animation using 3D computer graphics but also in virtual reality (VR) and augmented reality (AR) applications. In particular, the necessity is increasing for a technology for generating realistic 3D content images that can be played in real time on the latest high-resolution displays.

A method of generating a realistic rendered image according to the related art involves high-quality 3D shape data, such as a high-resolution mesh, various texture data, such as a material map, a normal map, etc., and large-scale high-speed computation through 3D graphic rendering hardware. However, this method requires much time and cost along with manual work of a professional 3D designer, and high-speed 3D graphic rendering hardware and high-capacity power for computation are necessary. Despite such efforts, real-time rendered human body images with limited computational time have a problem in that it is difficult to overcome discomfort from a cognitive point of view.

To solve this problem, research has been conducted on increasing the realism of rendered images by employing deep neural network (DNN) technology. Apart from this, research has been conducted on a technology for improving the quality of images, such as recovery of damaged images, an increase in resolution, noise removal, etc., a technology for easily editing images, such as combining two or more images, interpolating an image between two or more images, etc., and a technology for converting input real face images into new styles such as cartoons, comics, famous paintings, etc.

### SUMMARY OF THE INVENTION

The present invention is directed to providing a device and method for generating a realistic image at a low cost and in a short time by generating a rendering simulation image on the basis of a real image and generating a realistic image on the basis of the rendering simulation image.

According to an aspect of the present invention, there is provided a rendering method including receiving training image data including a real image, generating a rendering simulation image using the training image data, acquiring background feature information by separating foreground and background areas on the basis of the rendering simulation image or the training image data, acquiring latent feature information required for generating a realistic image on the basis of the rendering simulation image, and generating a realistic image on the basis of the latent feature information and the background feature information.

The rendering simulation image may include an image which simulates unrealism of a three-dimensional (3D) graphic rendering image using the training image data, and image data obtained using at least one of color distortion, noise, and image resolution degradation of the training image data or a style-transfer neural network.

The acquiring of the background feature information by separating the foreground and background areas may include separating the foreground and background areas into the foreground area which is a target object of realism visualization and the background area which is not a target object of realism visualization on the basis of the rendering simulation image or the training image data and acquiring the background feature information from the background area.

The acquiring of the latent feature information required for generating a realistic image on the basis of the rendering simulation image may include acquiring a latent vector and a multi-resolution feature map required for generating a realistic image by encoding the rendering simulation image.

The generating of the realistic image on the basis of the latent feature information and the background feature information may include generating a content map and a style map of the rendering simulation image from the latent feature information and generating a realistic image on the basis of the content map, the style map, and the background feature information.

The content map may be global content feature information, such as a category of an object to be rendered, object arrangement information, etc., and the style map may be feature information for determining a detailed structure of the object to be rendered, such as a pose, a facial expression, etc., and a texture feature including one of a color and texture.

The generating of the realistic image on the basis of the latent feature information and the background feature information may include, when noise is input, extracting a content map and a style map corresponding to the noise and generating a realistic image on the basis of the content map and the style map using a neural network model which is pretrained to output a realistic image as a result value.

The generating of the realistic image on the basis of the latent feature information and the background feature information may include, when the latent feature information and the background feature information are input to the pretrained neural network model, extracting a content map and a style map corresponding to the latent feature information and outputting a realistic image as a result value on the basis the content map corresponding to the latent feature information, the style map corresponding to the latent feature information, and the background feature information.

The rendering method may further include training a neural network using an error calculated on the basis of the realistic image.

The training of the neural network using the error calculated on the basis of the realistic image may include training the neural network using (e.g. by minimizing) an adversarial generative error calculated using a generative adversarial network structure having, as a generator, a neural network which generates a realistic image on the basis of the latent feature information and the background feature information.

According to another aspect of the present invention, there is provided a device for improving realism of a rendered image which is a computing device for visualizing realism of a rendered image, the device including at least one processor and a memory configured to store instructions executable by the processor. The processor receives training image data including a real image, generates a rendering simulation image using the training image data, acquires background feature information by separating foreground and background areas on the basis of the rendering simulation image or the training image data, acquires latent feature information required for generating a realistic image on the basis of the rendering simulation image, and generates a realistic image on the basis of the latent feature information and the background feature information.

In the case of acquiring the background feature information by separating the foreground and background areas, the processor may separate the foreground and background areas into the foreground area which is a target object of realism visualization and the background area which is not a target object of realism visualization on the basis of the rendering simulation image or the training image data and acquire the background feature information from the background area.

In the case of acquiring the latent feature information required for generating a realistic image on the basis of the rendering simulation image, the processor may acquire a latent vector and a multi-resolution feature map required for generating a realistic image by encoding the rendering simulation image.

In the case of generating the realistic image on the basis of the latent feature information and the background feature information, the processor may generate a content map and a style map of the rendering simulation image from the latent feature information and generate a realistic image on the basis of the content map, the style map, and the background feature information.

The content map may be global content feature information, such as a category of an object to be rendered, object arrangement information, etc., and the style map may be feature information for determining a detailed structure of the object to be rendered, such as a pose, a facial expression, etc., and a texture feature including one of a color and texture.

In the case of generating the realistic image on the basis of the latent feature information and the background feature information, the processor may extract, when noise is input, a content map and a style map corresponding to the noise and generate a realistic image on the basis of the content map and the style map using a neural network model which is pretrained to output a realistic image as a result value.

In the case of generating the realistic image on the basis of the latent feature information and the background feature information, the processor may extract, when the latent feature information and the background feature information are input to the pretrained neural network model, a content map and a style map corresponding to the latent feature information and output a realistic image as a result value on the basis the content map corresponding to the latent feature information, the style map corresponding to the latent feature information, and the background feature information.

The processor may train a neural network using an error calculated on the basis of the realistic image.

In the case of training the neural network using the error calculated on the basis of the realistic image, the processor may train the neural network using (e.g. by minimizing) an adversarial generative error calculated using a generative adversarial network structure having, as a generator, a neural network which generates a realistic image on the basis of the latent feature information and the background feature information.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram of a computing device (100) according to an exemplary embodiment of the present invention;

FIG. 2 is a diagram illustrating a configuration of the computing device (100) for visualizing realism according to an exemplary embodiment of the present invention;

FIG. 3 is a flowchart according to an exemplary embodiment of the present invention;

FIG. 4 is a diagram illustrating a learning process of a realistic image generator according to an exemplary embodiment of the present invention; and

FIG. 5A and FIG. 5B are images showing realism visualization results according to an exemplary embodiment of the present invention.

FIG. 6A and FIG. 6B are images showing realism visualization results according to an exemplary embodiment of the present invention.

FIG. 7A and FIG. 7B are images showing realism visualization results according to an exemplary embodiment of the present invention.

### DETAILED DESCRIPTION OF EXEMPLARY EMBODIMENTS

Since the technology described below may be variously modified and have several embodiments, specific embodiments will be illustrated in the drawings and described in detail. However, this is not intended to limit the present invention to the particular forms of implementation, which should be construed to include all modifications, equivalents, and substitutes included in the spirit and the technical range of the technology described below.

Although the terms “first,” “second,” “A,” “B,” etc. may be used herein to describe various components, the components are not limited by these terms. These terms are only used to distinguish one component from another. For example, a first component may be termed a second component, and similarly a second component may also be termed a first component, without departing from the scope of the technology described below. The term “and/or” includes any and all combinations of a plurality of listed relevant items.

As used herein, the singular forms are intended to include the plural forms unless the context clearly indicates otherwise. It is to be understood that the terms “comprise,” “include,” etc. specify the presence of described features, numerals, steps, operations, components, parts, or combinations thereof but do not preclude the presence or addition of one or more other features, numerals, steps, operations, components, parts, of combinations thereof.

Before the detailed description of the drawings, it is to be clarified that the distinction between components herein is merely a distinction by the main function of each component. In other words, two or more components to be described below may be combined into one component or one component may be divided into two or more components for subdivided functions. Also, each of components to be described below may additionally perform some or all of the functions that are handled by other components in addition to the main function of the corresponding component, and some of the main functions of components may be exclusively carried out by other components.

In performing methods or operating methods, a process of each method may be performed in a different order from that mentioned unless a specific order is clearly described in the context. In other words, each process may be performed in a specified order, performed substantially simultaneously, or performed in the reverse order.

Hereinafter, it is described that a computing device 100 for visualizing realism performs realism visualization. The computing device 100 is a device that processes input data in a certain manner and performs computation required for realism visualization according to a specific model or algorithm. For example, the computing device 100 may be implemented in the form of a personal computer (PC), a server in a network, a smart device, a chipset in which a design program is embedded, etc.

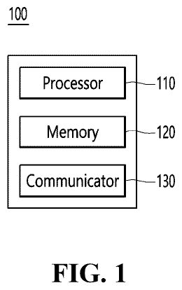

FIG. 1 is a diagram of the computing device 100 according to an exemplary embodiment of the present invention.

FIG. 1 is a block diagram of the computing device 100 for providing realism visualization according to an exemplary embodiment of the present invention. Components of the computing device 100 for providing realism visualization shown in FIG. 1 are illustrative. Only some of the components shown in FIG. 1 may constitute the computing device 100 for providing realism visualization, or an additional component other than those shown in FIG. 1 may be included in the computing device 100 for providing realism visualization.

As shown in FIG. 1, the computing device 100 for providing realism visualization may include a processor 110, a memory 120, and a communicator 130.

The communicator 130 may transmit and receive data to and from external devices, such as another electronic device, a server, etc., using a wired or wireless communication technology. For example, the communicator 130 may transmit and receive sensor information, a user input, a learning model, a control signal, etc. to and from external devices.

The memory 120 may store data which supports various functions of the computing device 100.

The processor 110 may determine one or more executable operations of the computing device 100. Also, the processor 110 may perform the determined operations by controlling the components of the computing device 100.

To this end, the processor 110 may request, search, receive, or use data of the memory 120 and control the components of the computing device 100 so that a predicted operation or an operation determined to be preferable may be performed among the one or more executable operations.

When a connection to an external device is necessary to perform a determined operation, the processor 110 may generate a control signal for controlling the external device and transmit the generated control signal to the external device.

To run an application program stored in the memory 120, at least some or a combination of the components of the computing device 100 may be controlled.

The computing device 100 according to the exemplary embodiment of the present invention may transmit and receive data through a mutual wireless and/or wired connection. The computing device 100 of the present disclosure may include any type of computing device which may compute an electronic form of data.

For example, the computing device 100 may be implemented as a fixed device or a mobile device, etc. such as a television (TV), a projector, a cellular phone, a smartphone, a desktop computer, a laptop computer, a digital broadcasting terminal, a personal digital assistant (PDA), a portable multimedia player (PMP), a navigation device, a tablet PC, a wearable device, a set-top box (STB), a digital multimedia broadcasting (DMB) receiver, a radio, a washing machine, a refrigerator, digital signage, a robot, a vehicle, etc.

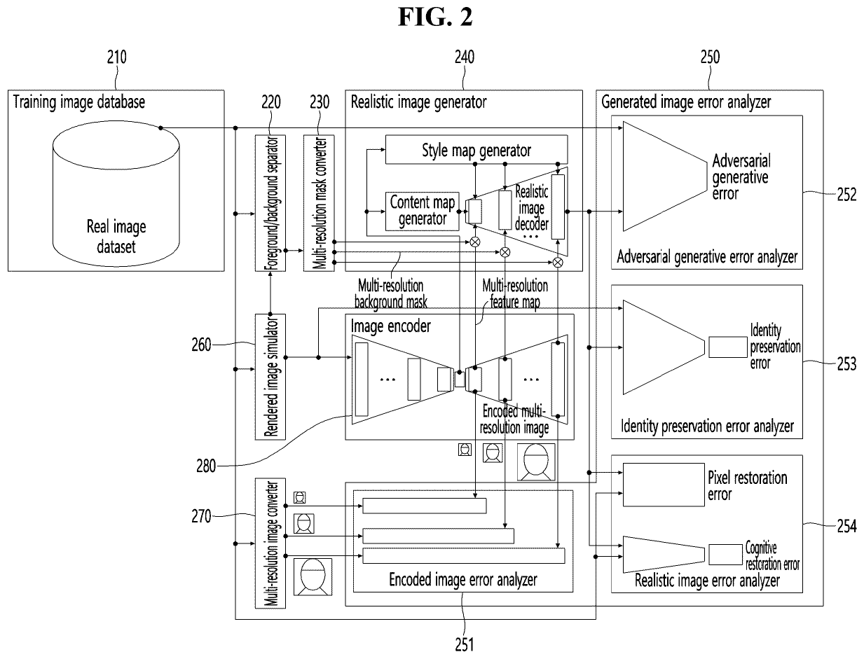

FIG. 2 is a diagram illustrating a configuration of the computing device 100 for visualizing realism according to an exemplary embodiment of the present invention.

Referring to FIG. 2, the computing device 100 for visualizing realism may be a device for improving the quality and realism of a rendered image. Also, the computing device 100 may include a training image database 210, a rendered image simulator 260, a foreground/background separator 220, a multi-resolution mask converter 230, a multi-resolution image converter 270, an image encoder 280, a realistic image generator 240, and a generated image error analyzer 250.

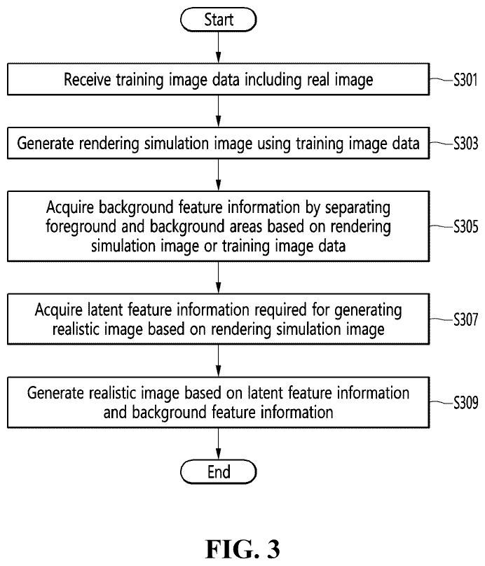

FIG. 3 is a flowchart according to an exemplary embodiment of the present invention.

First, a processor of a computing device for rendering which is trained with operations of the present invention may perform the following operations through the components of FIG. 2.

The processor may perform an operation S301 of receiving training image data including a real image, an operation S303 of generating a rendering simulation image using the training image data, an operation S305 of acquiring background feature information by separating foreground and background areas on the basis of the rendering simulation image or the training image data, an operation S307 of acquiring latent feature information required for generating a realistic image on the basis of the rendering simulation image, and an operation S309 of generating a realistic image on the basis of the latent feature information and the background feature information.

The operations according to an exemplary embodiment will be described in detail below with reference to FIGS. 2 and 3.

Referring to FIG. 2, the training image database 210 may include a real image dataset including high-quality real images for visualizing the realism of rendered images.

For example, the training image database 210 may include a real image dataset including high-quality real images which correspond to target object categories, such as human body, animal, object, etc., and have a variety of angles, shapes, lights, and backgrounds. The real image dataset may be stored in a physical medium, such as a hard disk or the like, or a cloud network platform (the training image database definitely includes training image data).

Also, the rendered image simulator 260 may receive a real image from the training image database 210 and generate a rendering simulation image which simulates an unrealistic rendered image.

In other words, the rendered image simulator 260 may receive a real image stored in the training image database 210 and convert the real image into an image which simulates the unrealism of a three-dimensional (3D) graphic rendering image, thereby generating a rendering simulation image.

For example, the rendered image simulator 260 may degrade the image quality of the received real image through image processing, such as color distortion, adding Gaussian noise, image resolution degradation, etc., thereby generating a rendering simulation image.

Also, the rendered image simulator 260 may convert an input real face image into a new style, such as a cartoon, a comic, a famous painting, etc., using a style conversion neural network, thereby generating a rendering simulation image.

Meanwhile, a method of simulating a rendered image according to the present invention is not limited to the above embodiment and may include various embodiments within a range in which those of ordinary skill in the art may set a detailed algorithm used in simulating a rendered image and an application probability and application strength used in a training process.

The foreground/background separator 220 may generate background feature information by dividing the real image in the training image database 210 or the rendering simulation image received from the rendered image simulator 260 into a foreground area which is a target object of realism visualization and a background area which is not a target object of realism visualization. Here, the background feature information may include a background mask including feature data of the background area and include various embodiments including background features.

Specifically, the foreground/background separator 220 may draw the foreground area and generate a background mask corresponding to the background area by removing the foreground area from the real image or rendering simulation image.

Meanwhile, the foreground/background separator 220 of the computing device 100 for visualizing realism according to the present invention may use real images in the training image database 210 as inputs in a learning process.

Subsequently, the foreground/background separator 220 which completes learning may separate a foreground and a background using only a rendered image without a real image in an inference process for visualizing the realism of the rendered image.

This is because an excessive error may occur in the foreground/background separation process when the degree of rendered image simulation is high in the learning process.

The multi-resolution mask converter 230 according to the exemplary embodiment of the present invention may convert a background mask image into a multi-resolution background mask by down-sampling the background mask image.

Also, the multi-resolution image converter 270 may convert a real image into a multi-resolution image by down-sampling the real image.

The multi-resolution mask converter 230 according to the exemplary embodiment of the present invention may perform scaling on the background mask image input from the foreground/background separator 220 using image interpolation. For example, an image may be generated by reducing horizontal and vertical sizes of the background mask image to ½, ¼, ⅛, etc. through the scaling.

Likewise, the multi-resolution image converter 270 performs scaling on a real image in the training image database 210 using image interpolation. For example, an image may be generated by reducing horizontal and vertical sizes of the real image to ½, ¼, ⅛, etc. through the scaling.

According to the present invention, feature data corresponding to various image scales may be generated through scaling and used in training and inference.

The image encoder 280 according to the exemplary embodiment of the present invention may acquire latent feature information required for generating a realistic image by encoding the rendering simulation image. Here, the latent feature information may include a latent vector and a multi-resolution feature map.

The image encoder 280 according to the exemplary embodiment of the present invention may include a deep neural network (DNN) that generates, through neural network training from the rendering simulation image input through the rendered image simulator 260, the latent vector required for visualizing the realism of the foreground area, the multi-resolution feature map required for generating the background area, and an encoded multi-resolution image which allows rapid and effective learning of the image encoder 280 through an encoded image error analyzer of the generated image error analyzer 250 to be described below.

To perform the operation, the image encoder 280 may include a neural network based on various algorithms. For example, the image encoder 280 may be a U-Net[Ronneberger2015] which is an end-to-end fully-convolutional network (FCN)-based model mainly used for image division and the like.

However, the structure of a neural network of the present invention is not limited to the example of the type of image encoder, and the neural network may be replaced with a neural network of another structure having a similar function.

The realistic image generator 240 may generate a realistic image on the basis of the latent feature information and the background feature information. Specifically, the realistic image generator 240 may generate a realistic image using the latent vector, the multi-resolution feature map, and the multi-resolution background mask of the encoded rendering simulation image.

The realistic image generator 240 according to the exemplary embodiment of the present invention may receive the latent vector and a multi-resolution feature map image from a neural network layer of the image encoder 280 and generate a realistic image.

Specifically, the realistic image generator 240 may include a content map generator which generates a content map from the latent vector input from the image encoder 280, a style map generator which generates a style map from the latent vector, and a realistic image decoder which decodes the realistic image on the basis of the content map, the style map, and a multi-resolution background area feature map obtained by performing computation with the multi-resolution feature map input from the image encoder 280 and the multi-resolution background mask input from the multi-resolution mask converter 230.

Here, the content map may represent global content feature information such as a category of an object to be rendered, object arrangement information, etc.

The style map may represent feature information for determining a local structure, such as a pose, a facial expression, etc. of the object to be rendered, and feature information for determining a textural feature such as color, texture, etc.

Meanwhile, the realistic image generator 240 according to the exemplary embodiment of the present invention may be based on StyleGan2[Karras2020] which is a neural network model used for the purpose of generating a high-quality image and the like.

However, the type of neural network model is just an example, and the neural network may be used with the structure and learning method thereof changed according to the basic principle for the purpose of maximizing the reality and fidelity of an input rendered image. Also, the neural network structure of the realistic image generator 240 may be replaced with a neural network of a new structure having a similar function.

The generated image error analyzer 250 according to the exemplary embodiment of the present invention may analyze encoding image errors, adversarial generative errors, identity preservation errors, pixel restoration errors, cognitive restoration errors, etc. for realism visualization and perform optimization.

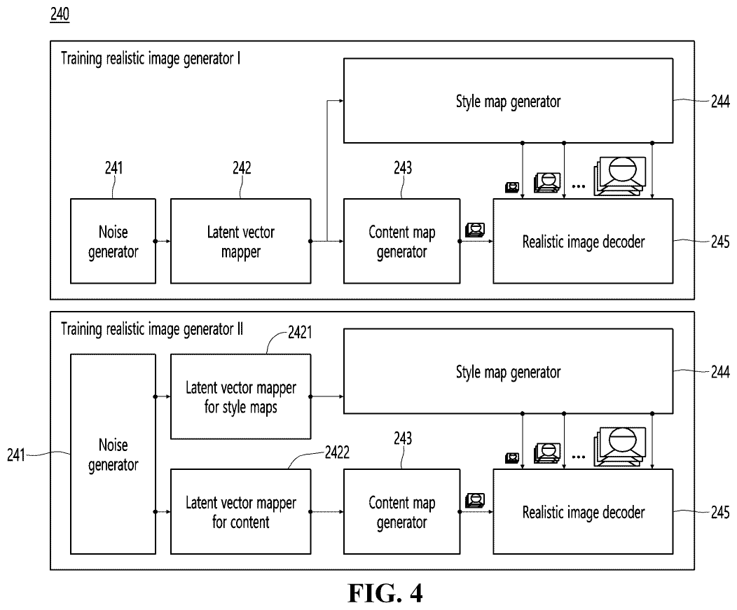

A method of training the realistic image generator 240 will be described below with reference to FIG. 4.

FIG. 4 is a diagram illustrating a learning process of a realistic image generator according to an exemplary embodiment of the present invention.

The realistic image generator 240 according to the exemplary embodiment of the present invention performs two-stage learning to effectively visualize the realism of a rendered image, and FIG. 4 shows a configuration of first-stage learning.

The first-stage learning is pretraining performed before training of the image encoder 280 which is the purpose of the present invention, and may be a learning process for extracting, when noise is input, a content map and style map corresponding to the noise and outputting a realistic image as a result value on the basis of the content map and style map.

Referring to FIG. 4, a training realistic image generator may be pretrained to generate a real image from noise.

Specifically, two exemplary embodiments will be described with reference to FIG. 4.

First, as shown in “training realistic image generator I,” the training realistic image generator may include a noise generator 241 which generates noise, a latent vector mapper 242 which converts the input noise into a latent vector, a style map generator 244 which generates a style map from the latent vector, a content map generator 243 which generates a content map from the latent vector, and a realistic image encoder 245 which receives the content map and generates a realistic image by repeatedly modulating the content map through upsampling using the style map.

In some cases, as shown in “training realistic image generator II,” a learning model may be configured by dividing the latent vector mapper 242 into a latent vector mapper 2421 for style maps and a latent vector mapper 2422 for content as independent structures.

The training realistic image generator according to an exemplary embodiment of the present invention may be trained through a process in which the training realistic image generator is used as a generator and configured as a discriminator for distinguishing between a generated image and a real image and the generator and the discriminator compete with each other.

According to the present invention, a training realistic image generator is configured as described above, and thus the following advantages may be obtained.

According to the present invention, as shown in FIG. 4, the performance of realism virtualization can be improved by pretraining the content map generator 243 and the style map generator 244.

Specifically, a content map is generated using a latent vector generated from noise, and thus there is an advantage in that generated images can have different content maps.

This can be differentiated from a case of using a fixed map that StyleGan2[Karras2020] according to the related art learns. Also, style information used for modulation in a realistic image decoding process can be applied for each pixel as a style map which is a two-dimensional (2D) map having multiple channels instead of style code which is applied for each existing channel layer of StyleGan2[Karras2020] and the like.

In other words, it is possible to generate a similar image to an input image later in a realism visualization process by increasing the amount of information on conditions used in realistic image decoding compared to an existing method of using a fixed content map which is not changed according to an input image or performing layer-specific modulation.

The style map generator 244 and the content map generator 243 are pretrained with real images through the first-stage learning of the training realistic image generator. Accordingly, in second-stage learning for visualizing the realism of a rendered image, the content map generator 243 and the style map generator 244 can generate a realistic image rapidly and effectively.

Subsequently, in the second-stage learning, learning may be performed as a process of learning visualization of the realism of a rendered image with a realistic image generator having the structure of FIG. 2 by removing a noise generator and a latent vector mapper from the training realistic image generator of the first stage.

Specifically, the second-stage learning may be performed by generating a realistic image on the basis of the latent feature information and the background feature information.

More specifically, when the latent feature information and the background feature information are input to the pretrained neural network model, the processor may extract a content map and style map corresponding to the latent feature information and train the realistic image generator so that a realistic image may be output as a result on the basis of the content map corresponding to the latent feature information, the style map corresponding to the latent feature information, and the background feature information.

In the case of generating a realistic image on the basis of the latent feature information and the background feature information, when the latent feature information and the background feature information are input to the neural network model trained through the above process, the pretrained neural network model may extract a content map and style map corresponding to the latent feature information and output a realistic image as a result on the basis of the content map corresponding to the latent feature information, the style map corresponding to the latent feature information, and the background feature information.

As an effect of the present invention, it is possible to learn visualization of the realism of a rendered image using only real images as input data particularly for realism visualization of rendered images and using a rendered image simulator instead of rendered images

In the present invention, a variable content map and a 2D style map for each input rendered image are used, and thus it is possible to maximize the reproducibility of a rendered image input to a realistic image generator.

Also, a realistic image generator receives information on foreground and background areas from an image encoder through a latent vector, and a pixel-wise multiplication operation is applied to a multi-resolution feature map received from the image encoder and a multi-resolution background mask received from a multi-resolution mask converter, according to each corresponding resolution so that a feature map of a background area is additionally acquired.

When foreground area and background area processing paths are separated in this way, background area information which is intended to keep information of an input image without change is directly transmitted from an image encoder to a realistic image decoder, and a foreground area which requires realism visualization is transmitted through a pretrained content map generator and style map generator. Accordingly, this is advantageous for realism visualization.

FIG. 2 will be described again. The generated image error analyzer 250 according to the exemplary embodiment of the present invention may include an encoded image error analyzer 251 for generating a realism visualization image, an adversarial generative error analyzer 252, an identity preservation error analyzer 253, and a realistic image error analyzer 254.

The DNN of the image encoder 280 and the realistic image generator 240 may be optimized in a learning process by minimizing an error analyzed by an error analyzer.

According to the present invention, a DNN in a foreground/background separator and a rendered image simulator, a DNN used for identity preservation error analysis by an identity preservation error analyzer of a generative image error analyzer to be described below, and a DNN used for cognitive restoration error analysis by a realistic image error analyzer of the generated image error analyzer may use pretrained model parameters without change and may not be updated, thereby being excluded from an optimization process.

The encoded image error analyzer 251 of the generated error analyzer 250 may calculate an error from a multi-resolution image input from the multi-resolution image converter 270 and an encoded multi-resolution image input from the image encoder 280 using a distance equation, such as L1 Norm, L2 Norm, etc., according to each resolution and calculate an encoded image error through a weighted sum.

Here, multi-resolution images input from the multi-resolution image converter 270 may serve as ground truth.

The adversarial generative error analyzer 252 of the generated image error analyzer 250 may include an adversarial neural network structure which uses the realistic image generator 240 as a generator and includes a discriminator in the adversarial generative error analyzer 252.

Also, a realistic image generated by the realistic image generator 240 may be input to the discriminator in the adversarial generative error analyzer 252 so that an adversarial generative error may be calculated. Here, the discriminator in the adversarial generative error analyzer 252 may be trained using the real image of the real image dataset in the training image database as ground truth and the image generated by the realistic image generator as a false.

The identity preservation error analyzer 253 of the generated image error analyzer 250 may calculate an error between the rendering simulation image which is obtained through the rendered image simulator 260 using a pretrained identity determination neural network in the identity preservation error analyzer 253, and the realistic image obtained through the realistic image generator 240. Meanwhile, the identity preservation error analyzer 253 is not a necessary element of the present invention and may be optionally used.

The realistic image error analyzer 254 of the generated image error analyzer 250 may receive the real image from the training image database 210 and the realistic image generated by the realistic image generator 240, calculate errors using pixel-wise distance equations, and draw a pixel restoration error by calculating an average of the errors.

Also, a pretrained object recognition neural network may be used as a feature extractor to obtain feature vectors from the real image of the training image database 210 and the realistic image generated by the realistic image generator 240, and an average error may be calculated from the feature vectors to draw a cognitive restoration error. Here, L1 Norm, L2 Norm, etc. may be used as an average error calculation method.

Examples of images of which the realism is visualized and that are generated using the neural network will be described below.

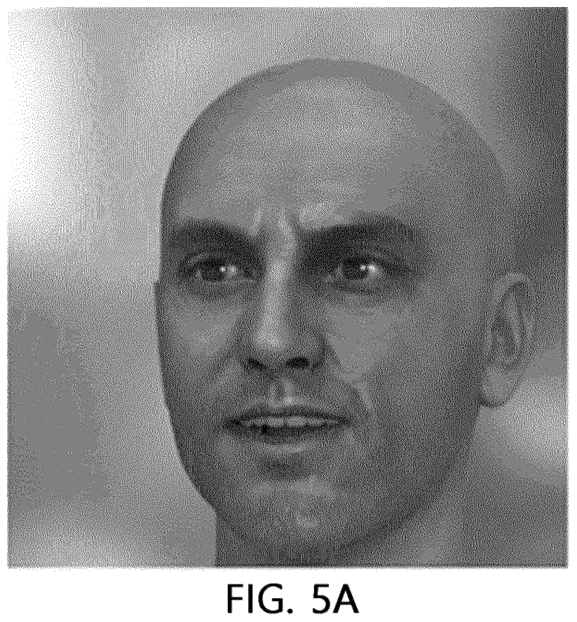

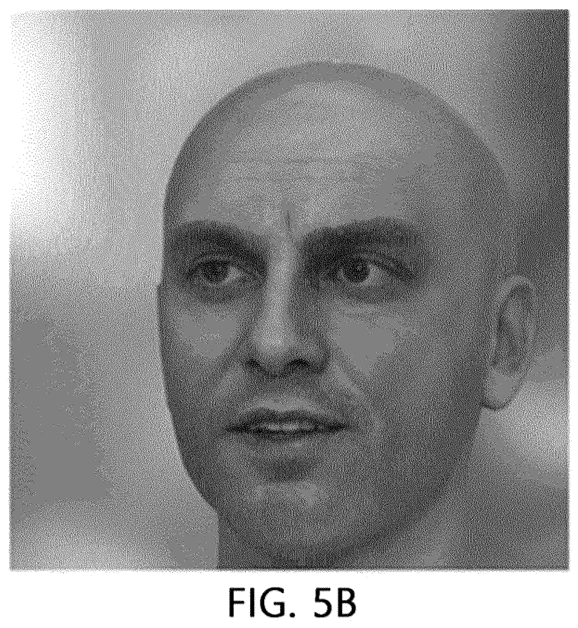

FIG. 5A and FIG. 5B are images showing realism visualization results according to an exemplary embodiment of the present invention.

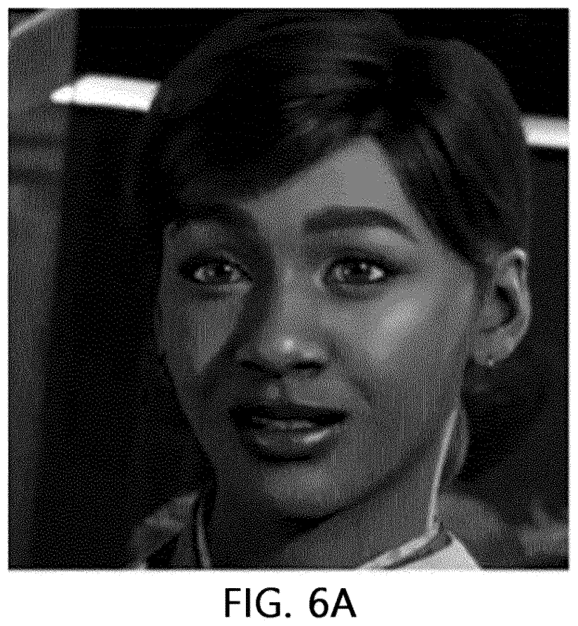

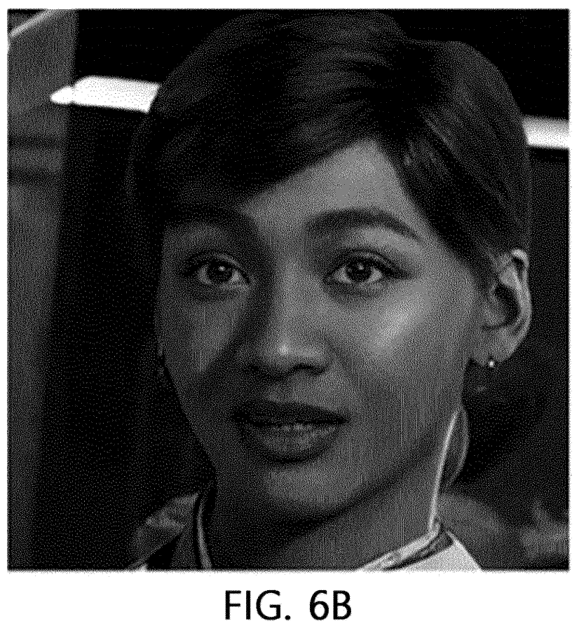

FIG. 6A and FIG. 6B are images showing realism visualization results according to an exemplary embodiment of the present invention.

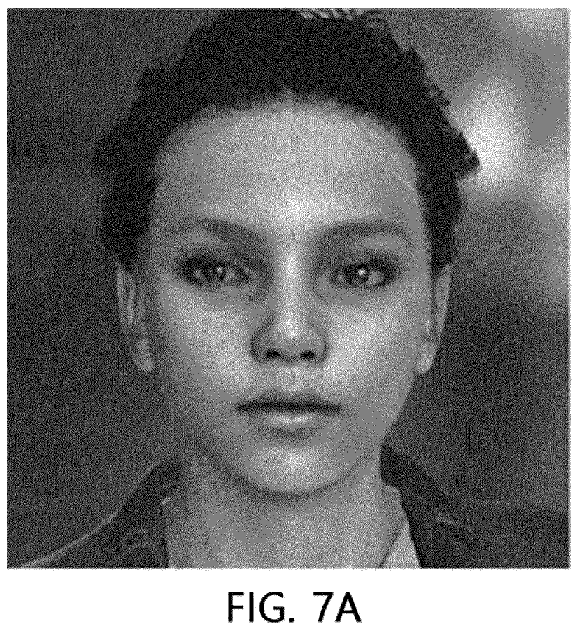

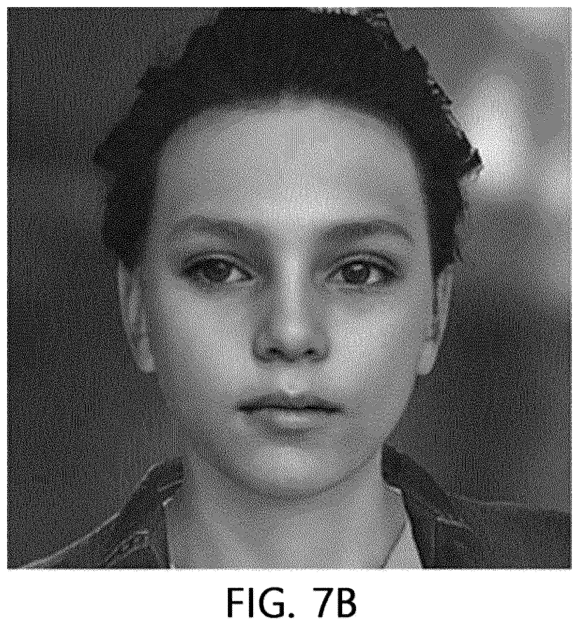

FIG. 7A and FIG. 7B are images showing realism visualization results according to an exemplary embodiment of the present invention.

FIGS. 5A to 7B show examples of rendered images to which realism visualization is applied according to the present invention. Specifically, FIGS. 5A, 6A, and 7A show rendering results before the realism visualization technology implemented through the present invention is applied, and FIGS. 5B, 6B, and 7B show rendering results obtained after the realism visualization technology implemented through the present invention is applied.

Although facial areas are shown as applicable objects for realism visualization according to exemplary embodiments of the present invention, realism visualization may be applied to entire areas of the human body and may be applied not only to human faces or bodies but also to other animals, such as dogs, cats, etc., and other objects such as furniture, vehicles, etc. Therefore, applicable targets and applicable areas of the present invention should not be construed as limited to the examples illustrated in the drawings.

According to the present invention, it is possible to provide a highly realistic image by applying a DNN having a suitable structure for realism visualization and a learning method to an image which is rendered using a 3D object model created at a low cost and in a short time.

What is claimed is:

1. A rendering method comprising:
receiving training image data including a real image;
generating a rendering simulation image using the training image data;
acquiring background feature information by separating foreground and background areas on the basis of the rendering simulation image or the training image data;
acquiring latent feature information required for generating a realistic image on the basis of the rendering simulation image; and
generating a realistic image on the basis of the latent feature information and the background feature information.

2. The rendering method of claim 1, wherein the rendering simulation image includes an image which simulates unrealism of a three-dimensional (3D) graphic rendering image using the training image data, and image data obtained using at least one of color distortion, noise, and image resolution degradation of the training image data or a style-transfer neural network.

3. The rendering method of claim 1, wherein the acquiring of the background feature information by separating the foreground and background areas comprises separating the foreground and background areas into the foreground area which is a target object of realism visualization and the background area which is not a target object of realism visualization on the basis of the rendering simulation image or the training image data and acquiring the background feature information from the background area.

4. The rendering method of claim 1, wherein the acquiring of the latent feature information required for generating a realistic image on the basis of the rendering simulation image comprises acquiring a latent vector and a multi-resolution feature map required for generating a realistic image by encoding the rendering simulation image.

5. The rendering method of claim 1, wherein the generating of the realistic image on the basis of the latent feature information and the background feature information comprises:
generating a content map and a style map of the rendering simulation image from the latent feature information; and
generating a realistic image on the basis of the content map, the style map, and the background feature information.

6. The rendering method of claim 5, wherein:
the content map is global content feature information, such as a category of an object to be rendered, object arrangement information, etc., and
the style map is feature information for determining a detailed structure of the object to be rendered, such as a pose, a facial expression, etc., and a texture feature including one of a color and texture.

7. The rendering method of claim 1, wherein the generating of the realistic image on the basis of the latent feature information and the background feature information comprises, when noise is input, extracting a content map and a style map corresponding to the noise and generating a realistic image on the basis of the content map and the style map using a neural network model which is pretrained to output a realistic image as a result.

8. The rendering method of claim 7, wherein the generating of the realistic image on the basis of the latent feature information and the background feature information comprises, when the latent feature information and the background feature information are input to the pretrained neural network model, extracting a content map and a style map corresponding to the latent feature information and outputting a realistic image as a result on the basis the content map corresponding to the latent feature information, the style map corresponding to the latent feature information, and the background feature information.

9. The rendering method of claim 1, further comprising training a neural network using an error calculated on the basis of the realistic image.

10. The rendering method of claim 9, wherein the training of the neural network using the error calculated on the basis of the realistic image comprises training the neural network using an adversarial generative error calculated using a generative adversarial network structure having, as a generator, a neural network which generates a realistic image on the basis of the latent feature information and the background feature information.

11. A device for improving realism of a rendered image which is a computing device for visualizing realism of a rendered image, the device comprising:
at least one processor; and
a memory configured to store instructions executable by the processor,
wherein the processor receives training image data including a real image, generates a rendering simulation image using the training image data, acquires background feature information by separating foreground and background areas on the basis of the rendering simulation image or the training image data, acquires latent feature information required for generating a realistic image on the basis of the rendering simulation image, and generates a realistic image on the basis of the latent feature information and the background feature information.

12. The device of claim 11, wherein the rendering simulation image includes an image which simulates unrealism of a three-dimensional (3D) graphic rendering image using the training image data, and image data obtained using at least one of color distortion, noise, and image resolution degradation of the training image data or a style-transfer neural network.

13. The device of claim 11, wherein, in a case of acquiring the background feature information by separating the foreground and background areas, the processor separates the foreground and background areas into the foreground area which is a target object of realism visualization and the background area which is not a target object of realism visualization on the basis of the rendering simulation image or the training image data and acquires the background feature information from the background area.

14. The device of claim 11, wherein, in a case of acquiring the latent feature information required for generating a realistic image on the basis of the rendering simulation image, the processor acquires a latent vector and a multi-resolution feature map required for generating a realistic image by encoding the rendering simulation image.

15. The device of claim 11, wherein, in a case of generating the realistic image on the basis of the latent feature information and the background feature information, the processor generates a content map and a style map of the rendering simulation image from the latent feature information and generates a realistic image on the basis of the content map, the style map, and the background feature information.

16. The device of claim 15, wherein the content map is global content feature information, such as a category of an object to be rendered, object arrangement information, etc., and
the style map is feature information for determining a detailed structure of the object to be rendered, such as a pose, a facial expression, etc., and a texture feature including one of a color and texture.

17. The device of claim 11, wherein, in a case of generating the realistic image on the basis of the latent feature information and the background feature information, the processor extracts, when noise is input, a content map and a style map corresponding to the noise and generates a realistic image on the basis of the content map and the style map using a neural network model which is pretrained to output a realistic image as a result.

18. The device of claim 17, wherein, in a case of generating the realistic image on the basis of the latent feature information and the background feature information, the processor extracts, when the latent feature information and the background feature information are input to the pretrained neural network model, a content map and a style map corresponding to the latent feature information and outputs a realistic image as a result on the basis the content map corresponding to the latent feature information, the style map corresponding to the latent feature information, and the background feature information.

19. The device of claim 11, wherein the processor trains a neural network using an error calculated on the basis of the realistic image.

20. The device of claim 19, wherein, in a case of training the neural network using the error calculated on the basis of the realistic image, the processor trains the neural network using an adversarial generative error calculated using a generative adversarial network structure having, as a generator, a neural network which generates a realistic image on the basis of the latent feature information and the background feature information.
